(19) United States
(12) Patent Application Publication
(10) Pub. No.: US 2013/0327014 A1
(43) Pub. Date: Dec. 12, 2013

(54) Devices and Methods to Optimize Aircraft Power Plant and Aircraft Operations

(71) Applicant: Djamal Moulebhar, Renton, WA (US)

(72) Inventor: Djamal Moulebhar, Renton, WA (US)

(21) Appl. No.: 13/914,441

(22) Filed: Jun. 10, 2013

Related U.S. Application Data
(60) Provisional application No. 61/658,837, filed on Jun. 12, 2012.

(51) Int. Cl. F02K 3/065

(52) U.S. Cl. CPC F02K 3/065
USPC 60/226.2

(57) ABSTRACT

Several improvements to optimize aircraft power plant and aircraft operations are disclosed, as well as methods of using these improvements to reduce fuel consumption, gas emission, noise, aircraft weight, maintenance costs, operating costs, aircraft incident and accidents, and improving aircraft performance. The improvements consist of a power plant fitted with a front propulsor, core engine, and aft propulsor. The fan of each propulsor is separated mechanically from the core engine. The front fan is separated mechanically from the aft fan. The aft fan is driven by free turbine that is supplied by exhaust gas of the core engine. If the core engine fails, both propulsors operate and provide thrust and reversed thrust when needed. If one propulsor fails, the other propulsor of the same power plant operates and provides thrust and reversed thrust.

### CROSS REFERENCE TO RELATED APPLICATIONS

This application claims priority to U.S. Provisional Patent No. 61/658,837, filed Jun. 12, 2012, which is herein incorporated in full for all purposes.

### GOVERNMENT SUPPORT

Not applicable.

### BACKGROUND OF INVENTION

1. Field of the Invention

This subject is related aircraft power plant and more specifically to devices and methods to optimize engine and aircraft operation during all ground & flight operations in order to reduce fuel consumption, gas emissions, noise, power plant maintenance cost, aircraft operating cost, and improve safety.

2. Description of Related Art

Fuel efficiency, environmental friendly aircraft, and noise are the main concerns of airliners and aircraft operators.

With fuel expense ranking as the number one (usually 40% of the total cost) or two cost categories, airlines are scrutinizing every step of theirs operations from tarmac to the sky searching for new ways to reduce the fuel consumption. They made big efforts and unprecedented measures to minimize their fuel expenditures and operating costs. However the use of conventional aircraft engines during ground & flight operations didn't help much to improve fuel conservation and reduce gas emissions and noise. Using single engine taxi procedure for 2 engines aircraft or 2/3 engines taxi procedure for 4 engines aircraft is very common in airlines in order to reduce fuel consumption. But this procedure may necessitate leaving the APU operating for long time if there is a long taxi line (congested airport), which increases the fuel consumption. If the APU is shutdown the crew has to use the cross-bleed air procedure in the taxiway to start the second engine. This procedure is not totally safe because the crew has to power up the first engine to a higher RPM to get higher thrust in order to start the second engine. This higher thrust can cause hazard because aircraft that are behind will be subject to the jet blast and FOD especially in congested airports. The emission gas from operating engine and APU may be ingested by the engine of other aircraft that is behind. In addition and in congested airport with a long line of aircraft in taxiway, the operating engine(s) is/are still generating useless thrust that is a waste of fuel.

However single engine taxi procedure cannot be used in all situations such as heavy loaded aircraft, uphill slope, soft asphalt, congested ramp areas, wet/slippery ramps and taxiways, turn on the operating engine at heavy weight, risk of jet blast and FOD for breakaway thrust especially heavy aircraft and 180 degree turn. In such situations aircraft taxi is performed with all engines operating at ground idle thrust (not fuel efficient at such relatively low or moderate RPM), which cause more fuel consumption and high taxi speed. Because of the high mass airflow through the bypass duct on turbofan engine, the ground idle thrust with all engines operating is normally greater than is required for the normal taxiing purposes. The crew has to control the taxi speed with frequent brake applications. This can cause excessive heat of the brakes and extend aircraft turn-around time because brakes must be cool before the next takeoff in case of RTO (rejected takeoff).

Longer aircraft turn-around time delays aircraft flight and increases the aircraft operating cost especially for short flights where a short turn-around time is very important. High taxi speed causes also wear brake. The majority of carbon brake wear occurs during taxi to and from the ramp where frequent brake applications are typically required. Extensive use of the brake during taxiing (due to high taxi speed because of high ground idle thrust) and during landing heat the brakes. Since the brake heat is cumulative, the brake cooling is very slow, and the time lag between brake application and wheel fuse plug melting, short-haul operations need extended turn-around time to avoid aircraft taxing with a wheel fuse plug melting. If the crew had exceeded the safe maximum quick turnaround weight during a previous landing without noticing it, they may face reduced takeoff performance, braking problem, and airframe damages from pieces of tire carcass.

Aircraft with MTOW (maximum take-off weight) can still takeoff if one engine fails at or after V1 (takeoff decision speed), even if this aircraft is 2 engines aircraft. A twin aircraft will lose 50% of the total aircraft thrust if one engine fails. The second operative engine will operate at maximum thrust to provide 100% of the total thrust in such case to substitute the loss of the thrust of the inoperative engine. A quad aircraft will lose 25% of the total aircraft thrust if one engine fails. Each of the 3 other engines will provide the third of the total aircraft thrust. So each engine has an excess of thrust that can be used if one of the engines fails during takeoff or in flight. This surplus or extra thrust means that each engine is overpowered and oversized (especially in twin aircraft) in order to cope with the failure of one of the engines even at maximum takeoff weight. This implies that the conventional aircraft engine is not optimized and sized for normal operations (all engines operating). Therefore conventional engine consumes more fuel and ejects more emission gas and noise during all phases of normal flight because of the extra weight and the extra drag of the conventional engine. The majority of the normal flights are performed using reduced takeoff thrust (assumed/flex or derated takeoff and sometimes both). The full takeoff thrust is used only on certain cases.

Moreover the aircraft is required to demonstrate its ability to climb and comply with takeoff requirements (field length, takeoff climb gradients, and obstacle(s) clearance . . . etc.) with one engine failure and even with maximum takeoff weight. These requirements imply surplus of thrust and the conventional engine must be overpowered and oversized in order to cope with a possible engine failure. Hence the extra weight and the extra drag of the conventional engine increase the fuel consumption, emission gas, and noise for normal operations since engine failure is not frequent event. The engine time limit for takeoff thrust is 5 minutes. The time limit for takeoff thrust is increased to 10 minutes provided this use is limited to situations where an engine fails and there is an obstacle in the takeoff flight path. That's an option that airline or aircraft operator can purchase. At such situation, there is a possibility of the failure of the operating engine because the high temperature, the pressure, and the stress developed in the operative engine affect engine reliability. Such problem is very serious especially during this critical phase of flight.

Conventional turbofan engines are fitted with large fan to increase the bypass duct airflow in order to increase fuel efficiency. Such engines have to contain fan blade within the engine housing in case of blade out, so it doesn't cause injuries to the passengers or damages to aircraft and engine. Such blade containment requires robust materials for the fan casing that add weight to the engine. Also larger fan requires larger engine nacelle and engine pylon. The increased size of the nacelle and engine pylon increase the drag and weight associated with the nacelle and the engine pylon. This cause more fuel consumption and gas emissions.

Current aircraft are fitted with larger fan on low wing-mounted engines, which means lower ground clearance. Therefore these aircraft require longer landing gears. This adds weight to aircraft that results in more fuel consumption and gas emissions. Engine lower ground clearance increases FOD (foreign object damage) risk.

Even though the rudder is not used a lot in flight, for conventional multi-engine aircraft (wing-mounted engine) the rudder and the vertical stabilizer are sized to overcome the yawing moment that occurs due to thrust asymmetry in case of engine failure. The rudder and the vertical stabilizer are sized also to generate sufficient sideslip for crosswind landings. This adds weight to the aircraft and cause more fuel consumption. Because of the thrust asymmetry due to engine failure, the engines on wing mounted engines are installed not farther from the fuselage (centerline of aircraft) in order to reduce the yawing moment: it is a compromise between the size of the rudder and the distance of the thrust centerline (engine) to center of gravity of aircraft. This yawing moment is a serious problem that can cause runway excursions (serious incidents or accidents) on ground especially at low speed below Vmcg (minimum control ground speed with critical engine out during takeoff roll) and below Vmca on air (minimum control air speed with critical engine out with airborne aircraft) because of aircraft control issues. However such engines installation (closer to the fuselage or the centerline of aircraft) reduces the wing bending relief moment, which necessitates wing structure strengthening. This implies more weight for aircraft and more fuel consumption.

By design the conventional engine is optimized for the cruise where it operates the most of time (especially for long and medium haul aircraft), which means that this engine is not optimized during all other phases of the flight. Such engine will consume more fuel during all other phases of flight. A short-haul aircraft or short flight for any aircraft consumes more fuel because of the cruise time is very short. During descent, approach and landing conventional aircraft engine is not fuel-efficient because it is not operating at optimum RPM.

Even though the modern aircraft engines are reliable, these engines may fail during a critical phase of flight especially takeoff (because of the high thrust where the temperature, pressure, and stress are high), or sometimes even during approach or landing where the thrust is not high. If the engine fails, it will not lose just the thrust but also will not provide electric, pneumatic, and hydraulic power for aircraft systems. Usually the engine core and its systems is the cause of the engine failures unless there is bird strike where the fan may be damaged depending on the size and the number of the birds. Even though the fan is virtually “maintenance free” it will be penalized to don't provide the thrust in case of engine core failure because the fan is related to the engine core through the low-pressure engine spool.

On takeoff the aircraft must comply with certain requirements such as runway length, takeoff climb gradients, obstacles clearance, takeoff thrust time limit, approach and landing climb gradients. These requirements might restrict an airplane's takeoff weight. The takeoff requirements are based upon the possible loss of engine: either at the most critical point at V1 or after V1 or at any point in takeoff path for obstacles clearance. If one of these requirements is a limiting factor the aircraft's takeoff weight must be reduced. Therefore aircraft payload and/or range capabilities are decreased; hence the operating cost increases, fuel efficiency decreases, and gas emissions increase. Even though engine failure is not frequent, from aircraft performance point of view engine failure at or after V1 is taken into account in the takeoff performance computation before each flight to comply with takeoff requirements. Hence aircraft performances are decreased, fuel consumption is increased and the operating cost for the majority of the normal flights (no engine failure) is highly increased if one of the requirements is limiting factor.

Here is an example (according to an article in Flight Safety Foundation) to illustrate the impact of the aircraft requirements on the operating cost. For quad aircraft the requirement for the minimum climb gradient for the second segment is 3% after engine failure. Usually this climb gradient is the most limiting takeoff climb requirement related to permissible takeoff weight. If for certain takeoff weight the second segment climb gradient is a limiting factor and equals 2.9%, the permissible takeoff weight of a Boeing 747 should be decreased by 3000 kg (6,614 pounds) to ensure the minimum required climb gradient for the second segment (3%). The weight of 3000 kg is the equivalent to the weight of 30 passengers and their baggage.

Sometimes runways are surrounded by obstacles that must be considered before the takeoff The net takeoff flight path must have a vertical clearance at least 35 feet above all obstacles lying within a defined area. In certain cases the second segment coincides with the obstacle. This may require complying with the second segment climb gradient and clearing the obstacle. Therefore the maximum takeoff weight may be reduced. In case of engine failure, aircraft drag is increased because of the drag of the deflected rudder and aileron (sometimes spoilers also) and the windmilling engine. Therefore aircraft performance decrease: takeoff distance increases (takeoff distance starts from brakes release to 35 ft altitude above dry runway or 15 Ft. altitude above wet runway), takeoff and approach climb gradients decrease, and obstacles clearance is reduced. The decrease of takeoff performance is taken in consideration in the takeoff performance computation before each flight to comply with takeoff requirements for a possible engine failure during takeoff. This reduces the takeoff weight in case of one of the takeoff requirements is a limiting factor. Therefore aircraft payload and range are decreased, operating costs are increased and fuel efficiency decreased for the majority of normal flights since engine failure is not a frequent event.

Turbofan engines are relatively slow in acceleration especially at relatively low and moderate RPMs because they have to ensure certain requirements such as stall margin and/or engine flame-out protection. Engine acceleration is nearly instantaneous around 80% RPMs. This slow acceleration at low and moderate RPM increases the takeoff roll. Normally for airliners, the rolling takeoff is recommended as takeoff procedure. Aircraft manufacturers recommend using rolling takeoff because of its advantages. The rolling takeoff is performed in two steps in order to avoid thrust asymmetry because conventional engines may have different engine response at low power setting. Same acceleration profile for all engines is reached from a certain relatively high thrust. The first step of the takeoff starts from ground idle thrust to certain intermediate thrust setting (around 50% N1 or 1.05 EPR) to allow the engine to spool up at the same rate in order to minimize any directional control problem. Once engines are stabilized and have the same N1 or EPR, the second step of the takeoff starts by advancing the thrust levers from the intermediate thrust setting to the takeoff thrust setting. The slow acceleration for conventional engines at low and moderate RPM and the two steps procedure for takeoff thrust setting decrease takeoff performance and increase fuel consumption and gas emissions. For example all engines operating (AEO) takeoff distance required (TODR) is increased, one engine inoperative (OEI) takeoff distance required (TODR) is increased, AEO and OEI accelerate-stop distance required (ASDR) are increased.

The turbofan slow acceleration at low and moderate RPM increases takeoff roll and a decrease in the accelerate stop distance available (ASDA). Turbofan decelerates relatively slow because of the risk of engine stall and/or flame-out due to the high inertia of low engine spool compared to high engine spool.

1) This slow deceleration decreases all engines operating (AEO) accelerate-stop distance available (ASDA).
2) If one engine fails near V1, the slow deceleration of the operating engine(s) and the non-use of thrust reversers of the inoperative engine decreases the accelerate-stop distance available especially in wet/contaminated runway (the use of thrust reversers is taken in account in a wet/contaminated runway only) and increase the risk of runway excursion below Vmcg. The crew will cancel the use of the thrust reversers of the operative engine if he faces control issue due to asymmetric reversed thrust which increases the accelerate-stop distance.
3) The low efficiency of the conventional thrust reversers and the higher engine spool-up time from ground idle to maximum reversed thrust increase ASDA.

The above 3 combined factors decrease more ASDA and can cause loss of aircraft performance. Also the use of the thrust reversers of the operative engine(s) may cause runway excursions after engine failure. Hence the risk of runway excursions is increased in case of high speed RTO especially near or at V1. A decrease of ASDA in case of high-speed RTO can cause runway overrun. Runway excursions and runway overrun can cause serious incidents and accidents and loss of aircraft. Among the frequent causes of high speed RTO (sometimes even above V1) are engine failures especially engine stall and engine fire.

Certain devices in aircraft such RAM (ram air turbine), APU (auxiliary power unit) and conventional thrust reversers are not used a lot, sometimes only on ground or sometimes in flight in emergency case but represent a dead weight for the majority of the flights (normal flights). Therefore these aircraft devices increase fuel consumption and gas emissions.

The conventional thrust reversers such cascade reversers are heavy, relatively unreliable, not used a lot during the majority of normal operations except for certain conditions, and usually used on ground at idle. They are not efficient: the airflow is not fully straight reversed, rather the reversed airflow is directed sideways with a certain angle around 40 degrees. In addition the exhaust gas of the core engine is not reversed. The thrust reversers are not even considered for aircraft certification and operation on dry runway. They are not efficient below certain aircraft speed.

On wet runway the thrust reversers are considered for aircraft performance operations. But the problem is if one engine fails, the crew will retract the thrust reversers of the other operative engine (in a twin aircraft) or the other symmetrical operative engine (in quad aircraft) if they face control issues due to the reversed thrust asymmetry. In such case the retraction of the thrust reversers will increase the accelerate stop distance available and the maximum brake energy. In quad aircraft if one engine fails, the crew will retract the thrust reversers of the other symmetrical operative engine if they face control issues due to the reversed thrust asymmetry. Since the thrust reversers will not be used if the crew faces control issues after engine failure the aircraft may face overrun because the thrust reversers are considered for computation of aircraft performance in wet runway.

Using intentional asymmetric thrust in conventional engines can be useful in certain cases to control roll but it is not precise because of the lag time associated with engine spool-up or spool-down. It is not desirable to use intentional asymmetric thrust unless no other means of roll control are available.

In several modern aircraft engines there are 3 kinds of idle thrust setting: ground idle, flight idle, and approach idle. Each of these thrust setting are not fuel-efficient because engines run below the optimum RPM. Also these thrust settings usually are in conflict with certain engine requirements. Also certain engine requirements are conflicting between each other. These engines are designed with a compromise between certain conflicting engine requirements and the convenient thrust for ground operations, descent, approach, or landing. This compromise affects enormously engine efficiency.

For example ground idle must be set to a certain minimum thrust setting to ensure ground taxiing thrust, minimum generator cut speed, engine bearings & seals pressure, and engine bleed air pressure. Also in the modern engines shaft power extraction demand can increase significantly especially to extract electric power from core engine. Such power extraction demand can negatively impact engine compressor surge margin. To mitigate this drawback an increase in the core engine speed to a certain minimum is needed. The problem is that at such minimum thrust setting aircraft turbofan engines generate more thrust than needed during taxing when all engines are operated. The extra thrust is the result of the high mass airflow through the bypass duct on turbofan engine especially on high bypass turbofan. Besides this extra thrust is waste of fuel, it also affects the ground operations handling like taxing when all engines are operating. Further, at reduced core speeds for ground idle, the resulting reduced pressure ratio in the compressor tend to affect performance characteristics. Another characteristic of these lower speeds is that the compressor discharge pressure and temperature are reduced; thereby increase the carbon monoxide emissions.

For the flight idle thrust setting it may be difficult to conciliate between decreasing the thrust to a minimum level (to reduce fuel consumption during descent) and ensuring certain engine flight requirements such as engine bearing & seals pressures, the bleed air pressure for aircraft, the minimum generator cutout speed, engine flame-out protection in inclement weather . . . etc. The setting of the flight idle is increased to improve engine compressor stability (increase engine surge margin) especially during descent. During this phase of flight engine has to maintain the off-power extracted from engine especially with the high demand of the electric power in modern aircraft. In addition the setting of flight idle is a waste of fuel since the pilot has to maintain aircraft speed using pitch and speedbrakes during descent. Flight idle thrust setting is also not fuel-efficient because the engine runs below the optimum RPM.

The jet engine is designed such that the acceleration is controlled to prevent engine from compressor stall or engine flame-out and to comply with engine and aircraft certification. Engine acceleration must comply with certain FAA regulations. FAR Part 33.73(d) requires 5 seconds or less to accelerate engine from 15% to 95% of go-around thrust (engine certification). FAR Part 25-119 requires that aircraft achieves a minimum climb gradient of 3.2% with the engines at the thrust that is available 8 seconds after initiation of the movement of the thrust levers from minimum flight idle to go-around thrust setting (aircraft certification).

Because of the slow acceleration of the engine at low and moderate rpm, the approach idle is set to a relatively high thrust (more than the flight idle) to generate the go-around thrust in a short time according to the FAA regulations FAR Part 33.73 (d) and FAR Part 25-119 in case of go-around. The go-around is not a frequent event and yet the approach idle is set to high thrust to comply with the FAA regulations. The approach idle is set automatically from the landing configuration until 4 seconds after touchdown. Therefore conventional engines aircraft are wasting fuel and increasing gas emission for the majority of normal flights (flights without go-around).

Also normal approach and landing configuration needs less than the approach idle thrust setting especially for low approach thrust and low approach drag where reduced flap extended setting and delayed extension of the landing are desirable to reduce the fuel consumption and reduce the noise.

At approach idle the engine is not fuel-efficient because it is operating below the optimum RPM where the engine is operating at relatively high RPM. At that thrust setting the high bypass turbofan provides an excess of thrust especially in high bypass engine where the most of the thrust is provided by the fan through bypass airflow. This excess of thrust generates high-energy approach (high and/or fast) that the pilot should plan ahead to manage this energy during the approach. This high energy may cause aircraft handling problems in approach and landing if not properly managed on time. An excess of energy may result in approach and landing serious incidents and accidents. High-energy (high/fast) and low-energy (low/slow) approaches were the cause in 66% of 76 approach and landing accidents and serious incidents worldwide in 1984 through 1997. High-energy approach represents 30% of the approach and landing accidents/incidents. High-energy approaches resulted in loss of aircraft control, runway overruns, runway excursions, and contributed to inadequate situational awareness in some CFIT incident. Rushed and unstabilized approaches are the largest contributory factor in CFIT and other approach-and-landing accidents. Flight-handling difficulties were the cause in 45% of 76 accident and serious incidents.

Certain aircraft have the tendency to don't slow down easily at approach. The relatively high setting of approach idle increases the approach energy. With high-energy approach it's difficult to reduce to final approach speed and to configure the aircraft in the landing configuration without exceeding flap placard speeds. In addition at high-density airport often ATC request pilot to maintain high airspeed to improve runway rate landing. This high energy of aircraft sometimes leads certain pilots to don't comply with ATC. An unstabilized or rushed approach can be the result of excess of aircraft energy and it may require extending the landing gears earlier and using of the speedbrakes to decelerate the aircraft (not recommended for some aircraft because of its effect especially if flaps are extended). This is a waste of fuel and an increase of gas emissions and noise. In addition this makes the flight uncomfortable because of the vibrations. Excess of aircraft energy may lead to go-around. Although this procedure is safer than landing with high energy, this procedure increases fuel consumption and affects runway landing rate.

Approach idle thrust setting is also used during inclement weather such heavy hail and/or rain or in flight icy conditions. In such cases the excess aircraft energy due to the excess of thrust (especially in high bypass engines) creates excess of speed and aircraft flight handling problem especially in case of heavy tailwind and/or heavy aircraft. On ground this may leads to serious problem such overrun landing especially on contaminated runway. In flight this high speed sometimes creates conflict for pilots. This high energy sometimes leads certain pilots to don't comply with ATC requests for maintaining high airspeed at high-density airport. In the same times pilots are required to maintain certain speed to comply with the stabilized approach requirements. Sometimes these pilots decelerate the aircraft for a stabilized approach without informing ATC about their inability to comply promptly with ATC request. This may lead to a loss of vortex spacing on final approach, a decrease on aircraft landing rate, and a probable of go-around. So slowing down jet aircraft especially on turbofan aircraft is serious matter mainly when it is necessary to quickly lose the speed in the final approach, flare, and even at landing. The tailwind especially in wet or contaminate runway, short runway, icing conditions, and the problem of aquaplaning cause a real risk for overrun. The excess of speed (due to wind additives) carried to the flare, plus the residual thrust during the flare (due to low spool down time for high bypass engines), plus the effect of float during the flare is serious risk for flight safety and generally leads to overrun.

Flying low-energy approach (i.e. low/slow) can be dangerous. Salvaging an increasing sink rate on an approach in a jet aircraft (compared to prop aircraft) can be a very difficult maneuver because the slow acceleration of the turbofan affects the recovery, assuming altitude loss cannot be afforded. Aircraft flying at low-energy approach represent 30% of approach and landing accidents/incidents. The slow acceleration of the turbofan engine increases aircraft stall speed when flying low-energy approach and affects aircraft recovery from stall (Turkish airlines B 737 crash flight 1951).

Multiple or all engines flame-out or failure (due to fuel depletion or contamination, volcanic ash cloud, bird strike, heavy hail/rain) is rare. When this event happens at cruise or relatively at high altitude, the crew may successfully land either by gliding (trading altitude with the speed) if there is no fuel or restarting engine(s) if possible. For example the crew of B 767 and A 330 (respectively Air Canada Flight 143 on 23 Jul. 1983 and Air Transat flight 236 on 24 Aug. 2001) successfully landed after fuel depletion. Also the crew of B747 (British Airways flight 9 on 24 Jun. 1982) and the crew of B747 (KLM Flight 867 on 15 Dec. 1989) successfully landed after restarting engine(s) after flame-out when aircraft flew into a cloud of volcanic ash.

But multiple/all engines flame-out or failure at low altitude and low speed is a very serious problem and may lead to crash. British Airways Flight 38 on 17 Jan. 2008 crash-landed just short of runway because of uncommanded thrust reduction. The crew of the US Air Flight 1549 (A320) ditched on 15 Jan. 2009 on Hudson River after both engines ingested birds.

The FAA regulation 25.671 FAR (d) states that airplane must be designed so that it is controllable if all engines fail. British Airways Flight 38 and US Air Flight 1549 illustrated that the controllability of aircraft after all engines failure (at low altitude and low speed) cannot ensure a safe landing without adequate thrust. Also at low speed and low altitude, aircraft controllability is affected by the lack of the thrust or no thrust at all. In such situation the primary flight controls need an important angle of deflection in order to control the aircraft because of the low speed of aircraft. Also at low speed aircraft cannot provide the adequate back-up hydraulic and/or electric power to actuate efficiently the primary flight controls: high bypass windmilling engines provide low hydraulic power (most of the air goes through the bypass duct and bypass the core engine), RAT (ram air turbine) provides lower power at low speed, APU is not operative if fuel is depleted, APU may take a precious time to turn it on and operate it, or APU may be dispatched inoperative. In addition windmilling engines provide lower hydraulic power if the fan is affected by bird strike or no hydraulic power at all if high spool shaft is sized. In addition multiple or all engines failure at low altitude increases crew workload at such critical situation: the crew of the US air flight 1549 spent (A320) spent a valuable time in vain to restart engines in critical phase of the flight (they were not aware of the extent of the engines damage).

Bird strike is a serious problem for aircraft especially if multiple or all engines ingested birds. Usually bird strikes occur at low altitude (final descent, approach, landing, takeoff and initial climb). Since at final descent, approach, or landing the engines are operating at moderate or relatively high RPM, there is a chance that the core engines will be affected by the debris of the birds and all engines may fail depending the size and the number of the birds. Sometimes the size and number of the birds ingested by the engines exceed the current bird ingestion certification standards as in US Air Flight 1549. Also the bird ingestion test certification requires 100% of the maximum thrust. But at takeoff the core engines may ingest the debris of the birds and the engines may fail because during these phases of flight most of the airlines are using reduced takeoff thrust: either assumed temperature takeoff thrust (flexible temperature takeoff thrust) or derated takeoff thrust (when conditions permit). The assumed and the derated takeoff thrust are reduced takeoff thrust settings i.e. less than 100% maximum thrust. In certain situations some aircraft are allowed to use up to 60% of the full power: derated takeoff thrust in addition to assumed temperature takeoff thrust used as a takeoff thrust. This may increase the chance that debris of the birds may enter the core of engine and cause engine failure in case of birds strike. The risk of core engines ingesting debris of the birds and engine failure is increased since most of the flights use reduced takeoff (when conditions permit) to reduce engine maintenance cost and increase engine reliability and efficiency. Same problem may happen when pilots use climb thrust and reduced climb thrust during climb. The reduced noise level of conventional bypass turbofan engines is attributable to the reduced exit velocities of airflow pressurized by the fans. The objectionable noise level is due to the high tip speeds of the large diameter fan blades. Another source of objectionable noise level is the difference between the exit speed of bypass air of the fan and the exit speed of gas of the core engine.

Noise-abatement requirements and procedures imposed by local airport authorities have affected airline operations in many ways, resulting in longer flight paths (more fuel consumption and gas emissions, and increased operating cost), restricted hours of operation, required sometimes weight offloads, fines, and surcharges. Certain airports have certain noise restrictions and sometimes curfew especially at night during engine run-up for maintenance.

Smaller and regional airports are underused. Large hub airports are congested. Air space is also congested resulting in high-level community noise in areas surrounding the airport. This increases fuel consumption, gas emission, and lengthens flight time and increases operating cost. Current aircraft approach runway at relatively shallow approach angle and fly long approach flight path. This causes noise problem to community residing near airport.

In order to test or troubleshoot aircraft engine components and systems, it is usually necessary to run the engine. This leads to many safety hazards around engines and aircraft and increases the use of fuel and the amount of resulting pollutants that enter the atmosphere. For example, it is not allowed (not safe and practical) to run a jet engine inside hangars or while the aircraft is lifted on jacks inside the hangar for maintenance purpose. When aircraft parked at an airport gate it is possible to run up the engine at idle for test and for a limited time and one engine running at time. Because of such restrictions, safety and environmental concerns, the engine must be run up outside of the hangar and away from the airport gate in a cleared area. Additionally, while the engine is running in remote location, there is always the danger that personnel, FOD (foreign object debris) might be sucked into the engine. Working around a running engine may lead to accidents and injuries that can be fatal mainly in the modern high/medium bypass ratio engines that are not fitted with inlet guide vanes. Performing maintenance work like leak checks especially at idle will expose the mechanic to the engine inlet suction especially if leak is situated in the fan case with open fan cowls (especially in engines with gearbox installed on the fan case). Some leak checks are performed at part power 70% N1: in this type of leak check, it is difficult to detect the leakage since the fan and the reverser cowls are closed. Even for idle leak check the thrust reverser cowls are closed. Personnel and objects can also be blown across the tarmac by the jet blast (high velocity and hot). This jet blast can injure workers and cause damage to surrounding objects.

For bigger engines especially certain twin wide body aircraft high bypass engine transportability and shipment is problem for airliners. The reason is because of the size of case fan and the fan in conventional high bypass engine necessitates the use of certain big aircraft for engine transportability and shipment.

What is needed then is a modification of the conventional aircraft gas turbine engine in order to optimize engine operations to reduce fuel consumption, gas emissions, noise, and also solve all the aforementioned problems. What is also needed is the incorporation of methods to optimize efficiently engine and aircraft operations during all ground and flight aircraft operations.

### SUMMARY AND OBJECT OF THE INVENTION

Fuel efficiency, environmental friendly aircraft, and maintenance costs are the main concerns of airliners and aircraft operators. It is possible to improve fuel efficiency by reducing fuel engine consumption, reducing aircraft weight, and reducing aircraft drag. According to this invention, the aircraft power plant comprises power plants and one auxiliary power unit. The power plant comprises front propulsor, the aft propulsor, and the core engine. A front air turbine and/or a front motor/generator drive the front fan. A free turbine and/or an aft motor/generator drive the aft fan. The core engine is separated mechanically and aerodynamically from the front propulsor and aft proplulsor. The core engine provides the electric and pneumatic power to drive respectively the front/aft motor-generator and the front air the turbine. In order to recover the energy of the exhaust gas of the core engine, exhaust gas drives the free turbine. The front propulsor and the front propulsor provide the thrust and the reversed thrust on ground and in flight. The front fan and the aft fan of a power plant can provide backup thrust and reversed thrust when needed in case of core engine failure. If one propulsor of the power plant fails, the other operative propulsor can still provide thrust and reversed thrust if needed. Un Auxiliary Power Unit (APU) provides also electric and pneumatic power to the propulsor. This APU can also provide electric, pneumatic and hydraulic power to aircraft systems. The APU is separate core engine and operates all times during normal and abnormal operations of the power plant.

The main goal of this invention is to reduce the fuel consumption, gas emissions, and noise by optimizing power plant and aircraft operations during ground and flight operations. Optimizing aircraft power plant requires the modification of the conventional aircraft engine by separating the mechanical link between the 2 fans and the core engine and fitting the power plant with 2 separate propulsors. Optimizing aircraft and power plant operations require also the incorporation of methods to optimize power plant and aircraft operations efficiently on ground and in flight.

It's an object of this invention to optimize aircraft and power plant operations in order to reduce fuel consumption and gas emissions

Another object of this invention is to optimize ground and flight aircraft operations such powerback, taxing, takeoff, climb, cruise, descent, approach, and landing to reduce fuel consumption, gas emissions, noise, and operating cost.

Further object of this invention is to improve aircraft takeoff performance, enroute performance, and aircraft approach and landing performance

Further object of this invention is to decrease the overall weight of the aircraft in order to reduce fuel consumption and gas emissions.

Another object of this invention is to improve safety and reducing the number of aircraft accidents and incidents by improving the redundancy of power plant and providing better control and management of aircraft energy especially at takeoff and landing, and ensuring back up thrust and reversed thrust for aircraft in case of core engine failure.

Further object of this invention is to reduce the operating cost of aircraft, improve long ETOPS flights (direct flights), reduce the flight time, and aircraft dispatch.

Another object of this invention is to prevent the failure of the aircraft power plant especially the core engine in case of bird strike and provide thrust at least through one propulsor.

Further object of this invention is to reduce engine maintenance cost, improve engine maintenance, engine transportability and shipment.

Another object of this invention is to unload major hub airports and air space by using underutilized airports and runways (with relatively shorter runways).

Further major object of this invention is to find a global solution to concerns and problems of airlines and aircraft operators.

### BRIEF DESCRIPTION OF THE FIGURES

FIG. 1 depicts as part of invention an advanced dual fan power plant 1 with 2 propulsors (2 & 4) and core engine 3 without mechanical link between them.

FIG. 1 depicts also the APU 15 and the power links of the APU 15 and the core engine 3 to the 2 propulsors (2 & 4).

FIG. 2 depicts as part of the invention an advanced propeller-fan power plant 21 with 2 propulsors (22 & 4) and core engine 3 without mechanical link between them. FIG. 2 depicts also the APU 15 and the power links of the APU 15 and the core engine 3 to the 2 propulsors (22 & 4).

FIG. 3 depicts as part of the invention an advanced dual counter-rotating fan power plant and core engine without mechanical link between them. FIG. 3 depicts also the APU 15 and the power links of the APU 15 and the core engine 3 to the 2 propulsors (32 & 4).

Each drawing illustrates a power plant comprising front propulsor, core engine, and an aft-propulsor and including a separate APU.

### DETAILED DESCRIPTION

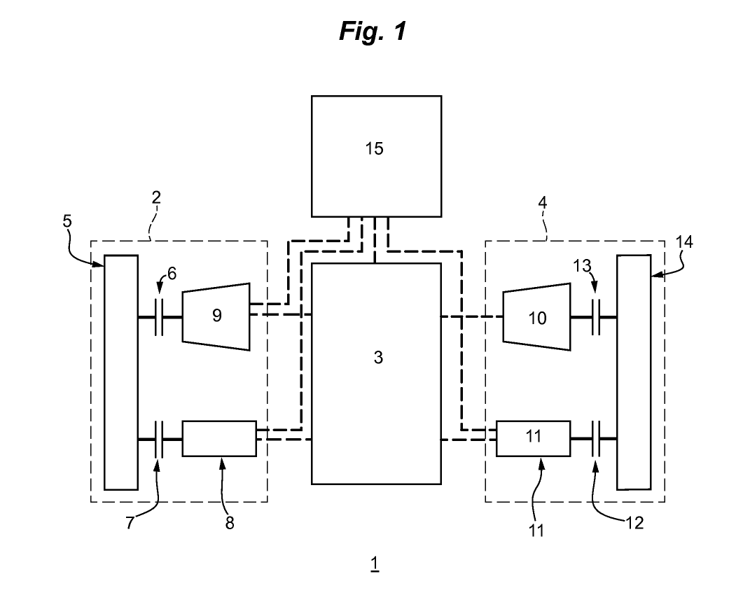

According to this invention and as illustrated in FIG. 1, the aircraft power plant 1 comprises a front propulsor 2, core engine 3, and aft propulsor 4. The front propulsor 2 comprises a front fan 5, a front motor-generator 8, and a front air turbine 9. The front fan 5 is driven by a front motor-generator 8 and an air turbine 9 to provide the thrust or the reversed thrust when needed. The front motor-generator 8 can be connected to the front fan 5 through a clutch 7 and the air turbine 9 is normally connected to the front fan 5 through a clutch 6. If the front motor-generator 8 fails, this motor-generator 8 can be disconnected from the front fan 5 through its clutch 7, such that the air turbine 9 drives the front fan 5. If the front air turbine 9 fails this air turbine 9 can be disconnected from the front fan 5 through its clutch 6, such that the motor-generator 8 drives the fan 5.

The front fan 5 is separated mechanically from the core engine 3 such that the core engine 3 does not drive the front fan 5. The front fan 5 is separated aerodynamically from the core engine 3 such that the front fan 5 does not supply air to the core engine 3. The front fan 5 is separated mechanically and aerodynamically from the aft fan 14.

According to this invention and as illustrated in FIG. 1 the aft propulsor 4 comprises an aft fan 14, aft motor-generator 11 and a free turbine 10. The aft fan 14 is driven by aft motor-generator 11 and a free turbine 10 to provide the thrust or the reversed thrust when needed. The aft motor-generator 11 is normally connected to the aft fan 14 through its clutch 12 and the free turbine is normally connected to the aft fan 14 through its clutch 13.

If the aft motor-generator 11 fails this motor-generator 11 can be disconnected from the aft fan 14 through its clutch 12, such that the free turbine 10 drives the aft fan 14. If the free turbine 10 fails this turbine 10 is disconnected through its clutch 13 from the aft fan 14.

The aft fan 14 is separated mechanically from the core engine 3 such that the core engine 3 does not drive the aft fan 14. The aft fan 14 is separated aerodynamically from the core engine 3 such that the aft fan 14 does not supply air to the core engine 3 but the exhaust gas from the core engine 3 drives the aft fan 14 through the free turbine 10 when the free turbine 10 is connected to the aft fan 14 through a clutch 13. The aft fan 14 is separated mechanically and aerodynamically from the front fan 5.

The clutches allow redundancy and flexibility of operation of the propulsor. But for simplicity it is possible the propulsors will not be fitted with clutches.

According to the FIG. 1, the core engine 3 provides electric power to drive the front motor-generator 8 and pneumatic power to drive the front air turbine 9. The core engine 3 provides also electric power to drive the aft motor-generator 11 and exhaust gas power to drive the free turbine 10. The core engine 3 supplies also electric, pneumatic, and hydraulic power to aircraft systems. The core engine is fitted with its own air inlet, so it does not depends on the front or aft fan.

If the core engine 3 of a power plant 1 fails the free turbine 10 is disconnected through its clutch 13 from the aft fan 14. Then the APU and/or the core engine 3 of other operating power plant 1 deliver back up pneumatic and electric power to the air turbine 9 and to the front motor-generator 8 and aft motor-generator 11, such that the front fan 5 and the aft fan 14 of power plant 1 with the failed core engine 3 can still provide back up thrust or back up reversed thrust when needed.

If the front fan 5 fails the aft fan 14 provides thrust or reversed thrust when needed wherein the core engine 3 provides electric power to the aft motor-generator 11 to drive the aft fan 14. Also the core engine 3 delivers exhaust gas to the gas turbine 10 to drive the aft fan 14.

If the aft fan 14 fails the front fan 5 provides thrust or reversed thrust when needed wherein the core engine 3 provides electric power to the front motor-generator 8 and pneumatic power to the front turbine 9 to drive the front fan 5.

The front fan 5 provides normal reversed thrust. Preferably the front fan 5 provides normal reversed thrust by varying the pitch of its blades and the front motor-generator 8 and the front turbine 9 drive the front fan 5. The front fan 5 can also provide normal thrust wherein the front motor-generator 8 drives in the reverse mode the front fan 5 and the front turbine 9 is disconnected from the front fan 5.

The aft fan 14 provides normal reversed thrust. Preferably the aft fan 14 provides normal reversed thrust by varying the pitch of its blades and the aft motor-generator 11 and the rear turbine 10 drive the aft fan 14. The aft fan 14 can also provide normal reversed thrust wherein the aft motor-generator 11 drives in the reverse mode the aft fan 14 and the rear free turbine 10 is disconnected from the aft fan 14.

The front propulsor 2 provides reversed thrust efficiently and without distorting airflow provided to the core engine 3 either by varying the pitch of the fan 5 or 14 or by reversing the rotation of the motor-generator 8 or 11. The front fan 5 is separated mechanically and aerodynamically from the core engine 3 such that the front fan 5 doesn't provide airflow to the core engine 3. The reversed thrust is generated by reversing the direction of the rotation of the front fan 5 through the reversing of the rotation of the front motor-generator 8 that drives the front fan 5 and disconnecting the front air turbine 9 from the front fan 5. Also the reversed thrust can be generated by varying the pitch of the blades of the front fan 5 and this fan 5 is driven by the front motor-generator 8 and the front turbine 10.

The aft propulsor 4 provides reversed thrust efficiently without distorting airflow provided to the core engine 3 either by reversing the rotation of the aft motor-generator 11 or by varying the pitch of the aft fan 14. The airflow is not distorted because the aft fan 14 is separated mechanically from the core engine 3 such that the aft fan 14 doesn't provide airflow to the core engine 3. The reversed thrust is generated by varying the pitch of the blades of the aft fan 14 and this fan 14 is driven by the aft motor-generator 11 and the aft turbine 10;

The front fan 5 and the aft fan 14 are accelerated rapidly and the spooling up time is reduced wherein:

The front fan 5 is separated mechanically and aerodynamically from the core engine 3 and the front fan 5 does not drive the core engine 3, therefore the inertia of the front fan 5 is reduced,

The front fan 5 is separated mechanically and aerodynamically from the core engine 3 wherein the front fan 5 does not provide air to the core engine 3 thereby the risk of the core engine 3 stall and flameout due to a rapid acceleration of the front fan 5 is eliminated,

The aft fan 14 is separated mechanically from the core engine 3 wherein the inertia of the aft fan 14 is reduced. The aft fan 14 does not supply air to the core engine 3 thereby the risk of the core engine 3 stall and flameout due to a rapid acceleration of the front fan 5 is eliminated.

The front fan 5 is driven simultaneously by the front motor-generator 8 and the air turbine 9. The aft fan 14 is driven simultaneously by the aft motor-generator 11 and the exhaust turbine 10 (free turbine).

The core engine 3 and the APU (not shown) are operating at nominal power and provide the maximum electric and pneumatic power respectively to the front motor-generator 8 and the aft motor-generator 11 and the front turbine 9 when rapid acceleration is needed.

The fans 5 and 14 are small and light with low inertia wherein the power plant 1 is fitted with the front fan 5 and the rear fan 14 instead of one big fan as in conventional turbofan engine. This ensures fast acceleration for the 2 separate fans.

The front fan 5 and the aft fan 14 are decelerated rapidly and the spooling down time is reduced wherein:

The front fan 5 is separated mechanically from the core engine 3 and the front fan 5 doesn't drive the core engine 3, therefore inertia of the front fan 5 is reduced. The front fan 5 is separated mechanically and aerodynamically from the core engine 3 wherein the risk of the core engine 3 stall and flameout due to a rapid acceleration of the front fan 5 is eliminated. The aft fan 14 is separated mechanically from the core engine 3 wherein the inertia of the aft fan 14 is reduced.

If fast deceleration is desired, the front motor-generator 8 and the air turbine 9 are disconnected simultaneously from the front fan 5 and the aft motor-generator 12 and the gas turbine 10 are disconnected from the aft fan 14. It is possible to decelerate rapidly the fans 5 and 14 by shutting off the electric power from the front motor-generator 8 and the aft motor-generator 11 and shutting off the pneumatic power from the air turbine 9 and the gas turbine 10 is disconnected from the aft fan 14.

Both fans 5 and 14 are small and light with low inertia wherein the power plant 1 is fitted with the front fan 5 and the rear fan 14 instead of one big fan as in conventional turbofan engine. This ensures fast deceleration for the separate fans 5 and 14.

The Auxiliary Power Unit 15 can be considered as separate core engine 3 and operated during normal and abnormal conditions of the power plant 1. The APU 15 may have the same core engine 3 of the power plant 1. The APU 15 provides electric and pneumatic power to the front propulsor 2 and electric power to the aft propulsor 4 such that the propulsors 2 and 4 generate thrust or reversed thrust when needed during normal operation of the power plant 1. After core engine failure 3 the APU 15 provides electric and pneumatic power to the front propulsor 2 and electric power the aft propulsor 4 such that the propulsors 2 and 4 generate back up thrust or reversed thrust when needed.

For better fuel efficiency it is preferable that the APU 15 is fitted with a free turbine to drive an electric motor, hydraulic pump, or compressor. The free turbine recovers the energy of the exhaust gas of the APU 15.

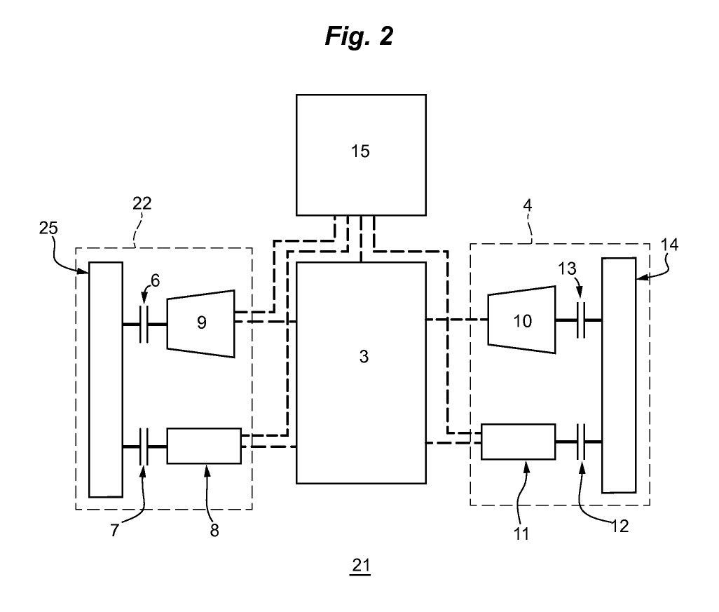

According to this invention the aircraft power plant can also be configured advanced propeller-fan 21 as illustrated in the FIG. 2. The core engine 3 and aft propulsor 4 of the power plan 21 are similar to the core engine 3 and the aft propulsor 4 of the power plant 1 and operate the same way as mentioned in the paragraph 1. The difference is the front propulsor 22 of the power plant 21 comprises a propeller 25 instead of front fan 5 of the power plant 1.

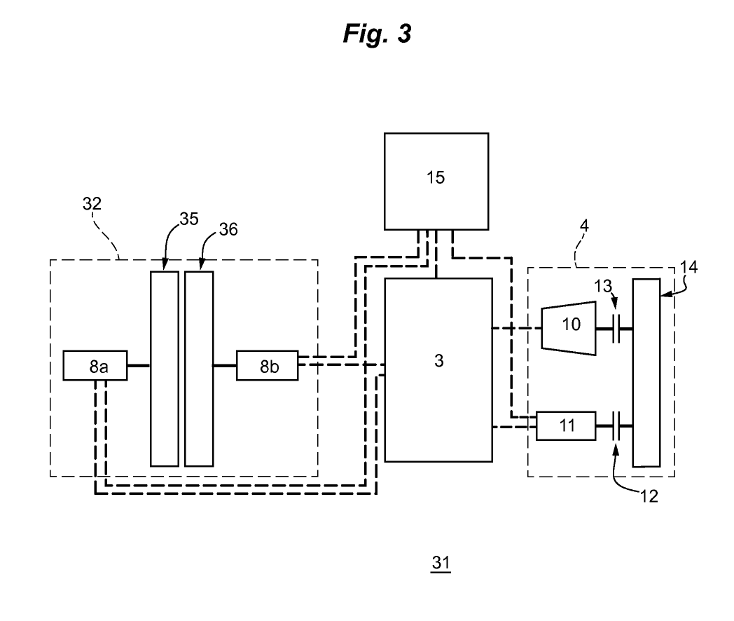

According to this invention the power plant can also be configured as advanced dual counter-rotating fan as explained in claim 4 and illustrated in the FIG. 3. The core engine 3 and aft propulsor 4 of the power plant are similar to the core engine 3 and the aft propulsor 4 of the power plant 1. The difference is the front propulsor 32 comprises dual counter-rotating fans 35 and 36 instead of one fan in the power plant 1. The fan 35 is driven by the motor-generator 8 and the fan 36 is driven by another similar motor-generator 8. The fan 35 is rotating in the opposite direction of the rotation of the fan 36. The fans 35 and 36 can be ducted or unducted.

According to this invention and especially for more electric aircraft (MEA) or all electric aircraft (AEA) the power-plant 1 (FIG. 1) can be configured such the front propulsor 2 comprises front fan and two motor-generators 8 instead of one turbine 9 and one motor-generator 8 in power-plant 1 in FIG. 1. The front propulsor 2 is driven by 2 motors-generators 8a and 8b instead of one turbine 9 and one motor-generator 8. Each motor-generator 8a/8b can be connected to the front fan 5 through a clutch.

### Main Characteristics of the Aircraft Power Plant:

### 1—Fuel Efficiency

The main goal of this invention is the reduction of fuel consumption, gas emissions. One of the methods to increase aircraft power plant 1 fuel efficiency is to separate the fans (5 & 14) mechanically and aerodynamically from the core engine. The fans (5 & 14) are not affected by certain conflicting requirements of the core engine 3, by the conflict between the core engine 3 and the fans (5 & 14) requirements, and by the conflict between the need of certain thrust settings during certain phases of flight and the power extracted from the core engine 3 for aircraft systems.

Therefore it is possible to optimize the power plant by driving the fan to the proper rotational speed that is adequate and convenient for each phase of ground and flight operations. For example according to this invention it is possible to provide adequate approach idle thrust (less than the approach idle thrust in conventional aircraft engine) without the need to set idle approach thrust high as in conventional engines. In these engines the idle thrust approach is set at relatively high setting to minimize acceleration time from approach idle thrust to takeoff thrust in case of a go-around.

2—Back Up Thrust and Reversed Thrust with Core Engine Failure

According to this invention, there is redundancy in the propulsion system. The power plant provides back up thrust and reversed thrust when needed even if the core engine 3 fails. If one propulsor (2 or 4) or fan (5 or 14) fails, the other propulsor (4 or 2) can deliver thrust and reversed thrust when needed. If the motor-generator (8 or 11) fails the turbine (9 or 10) drives the fan (5, or 14) respectively.

### 3—Fast Acceleration and Deceleration of the Propulsor

Other characteristic of this power plant is the fast acceleration and deceleration of the fan. This characteristic is possible because there is no mechanical link between the core engine and the fan. The fast acceleration and deceleration has a good impact on power plant and aircraft operations as explained in the claims.

### 4—The Effect of the Power Plant on the Aircraft Overall Weight Reduction

This invention not only reduce the weight of the power plant but also the aircraft overall weight wherein the weight of the power plant, the rudder and the vertical fin, wing are reduced as mentioned in the claims.

### 5—The Effect of the New Power Plant on Safety

As explained in the claims, aircraft accidents and incident are reduced or prevented such runway excursion, runway overrun, aircraft control loss due to thrust asymmetry.

### 6—Maintenance:

A method to improve efficiency of power-plant maintenance and safety of the maintenance and ramp crew around the power plant during core engine run-up for test and troubleshooting core engine components and systems.

This power plant reduces fuel consumption, gas emission, and noise. This power plant also decreases engine maintenance cost and aircraft operating costs and improves safety. This invention is a global solution to concerns and problems of airlines and aircraft operators.

### INCORPORATION BY REFERENCE

All of the U.S. patents, U.S. patent application publications, U.S. patent applications, foreign patents, foreign patent applications and non-patent publications referred to in this specification and related filings are incorporated herein by reference in their entirety. U.S. Pat. No. 7,805,947 and US Pat. Appl. Publ. No. 2010/0300117, which are co-assigned, are hereby incorporated by reference in full.

### SCOPE OF CLAIMS

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the claims included in this invention.

What is claimed is:

1. An aircraft comprising an aircraft power plants and an Auxiliary Power Unit (APU); the aircraft power plant comprises a front propulsor, a core engine, and an aft propulsor; the aircraft power plant can be configured in several configurations; the power plant can be configured as an advanced dual fan and comprises front propulsor, core engine, and aft-propulsor wherein:
a) The front propulsor comprises a front fan, a front motor-generator, and a front air turbine; the front fan is driven by a front motor-generator and an air turbine to provide the thrust or the reversed thrust when needed; the front motor-generator can be connected to the front fan through a clutch and the air turbine is may be connected to the front fan through a clutch; if the front motor-generator fails, this motor-generator can be disconnected from the front fan through its clutch, such that the air turbine drives the front fan; if the front air turbine fails this air turbine can be disconnected from the front fan through its clutch, such that the motor-generator drives the fan;
The front fan is separated mechanically and aerodynamically from the core engine such that the core engine does not drive the front fan and is not provided by air through the front fan; the front fan is separated mechanically from the aft fan;
b) The aft propulsor comprises an aft fan, aft motor-generator and a free turbine; The aft fan is driven by aft motor-generator and a free turbine to provide the thrust or the reversed thrust when needed; the aft motor-generator can be connected to the aft fan through a clutch and the free turbine can be connected to the aft fan through a clutch;
If the aft motor-generator fails this motor-generator can be disconnected from the aft fan through its clutch, such that the free turbine drives the aft fan; if the free turbine fails this turbine is disconnected through its clutch from the aft fan;
The aft fan is separated mechanically and aerodynamically from the core engine such that the core engine does not drive the aft fan; the aft fan is separated aerodynamically from the core engine such that the aft fan does not supply air to the core engine but the exhaust gas from the core engine drives the aft fan through the free turbine when the free turbine is connected to the aft fan through a clutch; the aft fan is separated mechanically from the front fan;
c) The core engine provides electric power to drive the front motor-generator and pneumatic power to drive the front air turbine; the core engine provides also electric power to drive the aft motor-generator and exhaust gas power to drive the free turbine; the core engine supplies also electric, pneumatic, and hydraulic power to aircraft systems;
d) If the core engine of a power plant fails the free turbine is disconnected through its clutch from the aft fan; then the auxiliary power unit (APU) and/or the core engine of other operating power plant(s) deliver back up pneumatic and electric power to the air turbine and to the front motor-generator and aft motor-generator, such that the front fan and the aft fan of power plant with the failed core engine can still provide back up thrust or back up reversed thrust when needed;
e) If the front fan fails the aft fan provides thrust or reversed thrust when needed wherein the core engine provides electric power to the aft motor-generator to drive the aft fan; also the core engine delivers exhaust gas to the gas free turbine to drive the aft fan;
f) If the aft fan fails the front fan provides thrust or reversed thrust when needed wherein the core engine provides electric power to the front motor-generator and pneumatic power to the front turbine to drive the front fan;
g) The front fan provides normal reversed thrust; preferably the front fan provides normal reversed thrust by varying the pitch of its blades and the front motor-generator and the front turbine drive the front fan; the front fan can also provide normal reversed thrust wherein the front motor-generator drives in the reverse mode the front fan and the front turbine is disconnected from the front fan;
h) The aft fan provides normal reversed thrust; preferably the aft fan provides normal reversed thrust by varying the pitch of its blades and the aft motor-generator and the rear turbine drive the aft fan; the aft fan can also provide normal reversed thrust wherein the aft motor-generator drives in the reverse mode the aft fan and the rear free turbine is disconnected from the aft fan;
i) The front propulsor provides reversed thrust efficiently and without distorting airflow provided to the core engine either by varying the pitch of the fan or by reversing the rotation of the motor-generator; the front fan is separated mechanically and aerodynamically from the core engine such that the front fan doesn't provide airflow to the core engine; the reversed thrust can be generated by reversing the direction of the rotation of the front fan through the reversing of the rotation of the front motor-generator that drives the front fan and disconnecting the front air turbine from the front fan; also the reversed thrust can be generated by varying the pitch of the blades of the front fan and this fan is driven by the front motor-generator and the front turbine;
j) The aft propulsor provides reversed thrust efficiently without distorting airflow provided to the core engine either by reversing the rotation of the aft motor-generator or by varying the pitch of the aft fan; the airflow is not distorted because the aft fan is separated mechanically from the core engine such that the aft fan doesn't provide airflow to the core engine; the reversed thrust is generated by varying the pitch of the blades of the aft fan and this fan is driven by the aft motor-generator and the aft turbine;
k) The front fan and the aft fan are accelerated rapidly and the spooling up time is reduced wherein:
The front fan is separated mechanically and aerodynamically from the core engine and the front fan does not drive the core engine, therefore the inertia of the front fan is reduced;
The front fan is separated mechanically and aerodynamically from the core engine, wherein the front fan does not provide air to the core engine thereby the risk of the core engine stall and flameout due to a rapid acceleration of the front fan is eliminated;
The aft fan is separated mechanically from the core engine wherein the inertia of the aft fan is reduced; the aft fan does not supply air to the core engine thereby the risk of the core engine stall and flameout due to a rapid acceleration of the front fan is eliminated;
The front fan is driven simultaneously by the front motor-generator and the air turbine.
The aft fan is driven simultaneously by the aft motor-generator and the exhaust turbine (free turbine);
The core engine and the APU are operating at nominal power and provide the maximum electric and pneumatic power respectively to the front motor-generator and the aft motor-generator and the front turbine when rapid acceleration is needed;
Both fans are small and light with low inertia wherein the power plant is fitted with the front fan and the rear fan instead of one big fan as in conventional turbofan engine; this ensures fast acceleration for the separate fans;
l) The front fan and the aft fan are decelerated rapidly and the spooling down time is reduced wherein:
The front fan is separated mechanically and aerodynamically from the core engine and the front fan does not drive the core engine, therefore inertia of the front fan is reduced; the front fan is separated mechanically and aerodynamically from the core engine wherein the risk of the core engine stall and flameout due to a rapid acceleration of the front fan is eliminated, the aft fan is separated mechanically from the core engine wherein the inertia of the aft fan is reduced;
If fast deceleration is desired, the front motor-generator and the air turbine are disconnected simultaneously from the front fan and the aft motor-generator and the gas turbine are disconnected from the aft fan; It is possible to decelerate rapidly the fans by shutting off the electric power from the front motor-generator and the aft motor-generator and shutting off the pneumatic power from the air turbine and the gas turbine is disconnected from the aft fan;
Both fans and are small and light with low inertia wherein the power plant is fitted with the front fan and the rear fan instead of one big fan as in conventional turbofan engine; this ensures fast deceleration for the separate fans;
m) In case of loss of thrust and aircraft power, the power plant generates back up electric power wherein:
The front motor-generator provides back up electric power to certain critical aircraft systems such that the windmilling front fan drives the front motor-generator to generate back up electric power after disconnecting the air turbine from the front fan; the aft motor-generator provides back up electric power to certain critical aircraft systems such that the windmilling aft fan drives the aft motor-generator to generate back up electric power after disconnecting the free turbine from the aft fan;
m) The Auxiliary Power Unit is considered as separate core engine and operated all times during normal and abnormal conditions of the power plant. The APU can have the same core engine of the power plant; the APU provides electric and pneumatic power to the front propulsor and electric power to the aft propulsor such that the propulsors and generate thrust or reversed thrust when needed during normal operation of the power plant; the APU provides also electric and pneumatic power to aircraft systems when needed; after core engine failure the APU provides electric and pneumatic power to the front propulsor and electric power the aft propulsor such that the propulsors generate back up thrust or reversed thrust when needed;
The APU is fitted with a free turbine to drive an electric motor, hydraulic pump, or compressor; the free turbine recovers the energy of the exhaust gas of the APU;
n) The aircraft power plant can also be configured as advanced propeller-fan; this power plant comprises a front propulsor, a core engine, and an aft-propulsor wherein:
The core engine and aft propulsor are similar to the core engine and the aft propulsor of the advanced dual fan power plant and operate the same; the difference is the front propulsor of the propeller-fan comprises a propeller instead of front fan; for more electric aircraft (MEA) or all electric aircraft (AEA) the propeller can be driven by 2 motor-generators instead of one turbine and one motor-generator;
O) The power plant can also be configured as advanced dual contra-rotating fan; this power plant comprises a front propulsor, a core engine, and an aft-propulsor wherein:
The core engine and aft propulsor are similar to the core engine and the aft propulsor of the advanced dual fan power plant; the difference is the front propulsor comprises dual counter-rotating fan instead of one fan; each fan in the front propulsor is driven by a motor-generator; each fan is rotating in the opposite direction of the rotation of other fan;

2. The aircraft powerplant of claim 1 wherein, the fuel consumption and gas emissions of the aircraft power plant is reduced wherein:
a) The front fan and the aft fan are separated mechanically from the core engine from the core engine such that:
The operation of the propulsors especially the fans are not affected by certain conflicting requirements of the core engine, by the conflict between the core engine and the fans requirements, and by the conflict between the need of certain thrust settings during certain phases of flight and the power extracted from the core engine for aircraft systems;
b) The inexistence of mechanical tie between the front and aft fan and the core engine increases the fuel efficiency of the power plant by driving the front fan and the aft fan to the proper RPM, such that the front fan and the aft fan provide the adequate and convenient thrust or reversed thrust for each phase of ground and flight operations;
c) The mechanical separation between the front and aft fan and the core engine allows the optimization of the core engine by operating it at optimal rpm during all phases of flight and within short range of variation of the rpm during its operation depending on power extracted from the core engine;
d) The electric and pneumatic power that drives motor-generator and the turbine are transmitted efficiently to the fans especially if the front fan is driven by 2 motor-generators instead of one turbine and one motor-generator;
e) The overall aircraft weight is reduced as illustrated in paragraph 6 wherein lighter aircraft consumes less fuel since extra weight needs an extra fuel or a certain given range; the extra weight of aircraft and the extra weight of fuel decrease the payload and/or the range of aircraft;
f) Flying at the same cruise altitude without altitude driftdown after core engine failure wherein:
The power plant with the failed core engine provides back up thrust through its front and aft fan as illustrated in paragraph 1(d),
The core engine windmill drag and the spillage drag are reduced and aircraft control drag is eliminated by providing back up thrust through the front propulsor and aft propulsor of the power plant as explained in paragraph 1(d);
f1)—Flying at the same cruise altitude without altitude driftdown after the failure of one of the 2 propulsors of the power plant wherein:
The thrust is provided by operating the other operative propulsor of the power plant as mentioned in the paragraph 1(e) and 1(f) at the required thrust in order to reduce thrust asymmetry;
The control drag is reduced by providing the required thrust through the other operative propulsor of the same power plant to reduce the yawing and the roll moment due to the thrust asymmetry; the aircraft control drag can also be reduced by reducing the thrust or eliminated by shutting down the opposite propulsor of opposite operative power plant if needed during a certain specific phase of flight such as the descent;
g) The propulsor generates either thrust or reversed thrust whatever is needed and not both in the same time by separating mechanically the operation of the fans from the core engine as illustrated in paragraphs 1(a) and 1(b);
h) The propulsor generates in flight either thrust or reversed thrust whatever is needed and not both in the same time by separating the operation of the fans from the core engine as illustrated in paragraphs 1(a) and 1(b);
i) During taxiing in congested airport (long queue) while the aircraft is not moving, the front propulsor and the aft propulsor are shutdown and only the core engine is operating to provide power to aircraft systems;
j) The energy of exhaust gas from the core engine of the power plant and the APU is recovered by driving a free turbine;
k) The improvement of takeoff, enroute, approach, and landing performance as indicated in paragraphs 4 and 5 increases the takeoff weight (if limited by certain requirement) due to back up thrust after core engine failure as illustrated in claim 1(d), or one propulsor failure, wherein the payload weight is not decreased because the takeoff performance requirements are improved and there is no limiting factor for takeoff weight as in conventional engine after engine failure;
l) During the descent the thrust setting of flight idle is reduced without affecting the electric, pneumatic, and hydraulic power extracted from the core engine and delivered to aircraft systems wherein: the front fan and/or the aft fan are driven at lower rpm to provide the adequate thrust during the descent, and the core engine is operating to the proper speed to supply the adequate power to aircraft systems and the propulsors;
It is possible to maintain the descent speed below Vmo/Mmo without using aerodynamic brakes by driving the front and the aft fan at lower RPM or eliminate the thrust or providing a reversed thrust if needed;
m) On approach phase of flight the approach idle thrust setting is set to a lower thrust comparable to approach idle in a conventional engine aircraft, and this thrust is still adequate for the approach phase wherein:
The front fan and the aft fan can be accelerated rapidly and the spooling up time is reduced as explained in claim 1(k) in case of go-around, and these fans generate the required thrust during the required time and complying with the FAA regulations FAR Part 33.73(d) & FAR Part 25-119;
n) The fuel consumption is decreased and gas emission is reduced during core engine run-up to test and troubleshoot core engine systems and components wherein:
The front fan and the aft fan are not running, the energy of exhaust gas of the core engine is recovered through the free turbine that drives the aft motor-generator which generates electric power;
The test and the troubleshooting can be performed at the airport gate/apron without the need to taxi or tow aircraft to a remote location for core engine run up and bring back it to airport gate/apron as explained in paragraph 9(e);
The test and the troubleshooting can be performed outside of the hangar, and if needed inside the hangar with exhaust gas directed to outside without the need to tow aircraft to a remote location for core engine run up and bring back it to the hangar as explained in paragraph 9(e);
o) It is possible to reduce the takeoff roll and perform higher and shorter flight path to avoid noise abatement requirements, procedures, and penalties by:
Performing one step rolling takeoff procedure directly from brakes release to the takeoff thrust setting without halting for certain time the takeoff procedure on a certain intermediary point between the brakes release and the takeoff thrust setting;
Performing rapid acceleration of the front fan and the aft fan as explained in paragraph 1(k);
p) In congested airport the total flight time of a trip is decreased by:
Reducing the taxi time which consists in performing intersection takeoff using one-step takeoff procedure directly from brakes release to the takeoff thrust setting without halting for certain time during the takeoff procedure on a certain intermediary point between the brakes release or the rolling takeoff point and the takeoff thrust setting;
Using the concept of rapid acceleration of the fans as explained in paragraph 1 (k);
r) The drag of the power plant is reduced wherein:
The frontal surface of the power plant is reduced by fitting the power plant with 2 coaxial fans, the front fan at the front of the power plant and the aft fan at the rear of the power plant instead of fitting one big fan as in conventional power plant as illustrated in claim 1;
The drag of aircraft related to the rudder and the vertical stabilizer is reduced by reducing the size of the rudder and the vertical stabilizer as illustrated in claim 6(c);
s) Twin medium/long-haul aircraft fly directly to the airport destination using shorter and direct routes especially for long ETOPS flights, polar flights or over high mountains or terrain wherein the redundancy of the thrust in the power plant that consists in providing back up thrust in case of core engine failure as indicated in paragraph 1(d) or one propulsor failure as indicated in paragraph 1(e) allows twin aircraft to be considered as tri or quad aircraft;
t) The ETOPS fuel reserve is reduced by flying at the same cruise altitude without altitude driftdown after power plant failure wherein the redundancy of the thrust allows using back up thrust in case of core engine failure as indicated in paragraph 1(d) or one propulsor failure as indicated in paragraph 1(e);
u) During descent it is possible to provide a gliding descent (no thrust) by eliminating the thrust if needed by shutting down the 2 propulsors and the core engine is still operating and providing the adequate power to aircraft systems wherein:
The pilots can perform steep and gliding (no thrust) descent without using aerodynamic brakes and may be using one or two propulsors as thrust reverser for stepper descent if needed;
The front fan and the aft fan are windmilling and driving respectively the front and the aft motor-generators that generate electric power as illustrated in claim 6 (g);

3. The airplane of claim 1, wherein aircraft ground operations are improved by a powerback and single core engine taxiing, wherein:
a) The powerback is used instead to pushback by operating one core engine and APU if needed in 2 power plants aircraft or more than one core engine and APU in aircraft with more than 2 power plants to provide power to one fans or both fans;
In 2 power-plant aircraft the crew can use the two front fans, the two aft fans, or any other combination of front fans and aft fans of the 2 power plants depending on the need to provide forward breakaway thrust first in order to “break it loose” and once the aircraft is loose less reversed thrust is used to roll back easily the aircraft;
In 4 engines aircraft the crew can use all the front fans or aft fans or any combination of core engine(s) and APU and front fans and aft fans of the 4 power plants depending on the need;
During power back the risk of FOD (foreign object damage) in wing-mounted engines is minimized because the air inlet of the core engine is located on the upper side and the front fan and aft fan are separated mechanically and aerodynamically from the core engine.
During power back the risk of FOD (foreign object damage) in wing-mounted engines is minimized because the clearance between the power plant 1 and the ground is convenient to preclude FOD wherein the power plant is fitted with 2 small fans instead of one big fan;
During power back and using only aft fans the risk of FOD in wing-mounted engines is more minimized since the air inlet of the core engine is located upstream of the aft fan;
During power back the risk of FOD is minimized on power plant with low and dihedral wing-mounted engines by installing the power plant farther from the fuselage, or the aircraft centerline in order to increase the clearance between the power plant and the ground without increasing the risk of thrust asymmetry as illustrated in paragraphs 7(a), 7(b), 7(c), and 7(d);
b) The taxiing is performed by operating one core engine and APU if needed in 2 power plants aircraft to provide power to the fans; the crew can use the two front fans, two aft fans, or any other combination of front and aft fan and core engine(s) of the 2 power plants depending on the need to provide the adequate idle ground thrust and the convenient aircraft speed for taxiing without using a lot the brakes and without limiting the electric, pneumatic, and hydraulic power extracted from the core engine and needed for aircraft systems;
For the taxiing in 4 engines aircraft the crew can use all the front fans with 2 operative core engines and APU if needed, or any other combination of core engines and APU and aft fans and front fans of the 4 power plants depending on the need;
The control of aircraft speed during taxiing is performed by:
First controlling the rpm of the operating fans to provide the adequate thrust for the taxiing according to the need,
Using these operating fans as thrust reversers by providing the reversed thrust or reducing the rpm of the operating fans if reducing aircraft taxiing speed is needed
Or even shutdown these fans when needed to reduce aircraft taxing speed independently from the core engine;

4. The airplane of claim 1, wherein aircraft takeoff and enroute performance are improved, wherein:
a) All engines operating (AEO) takeoff distance is reduced wherein the rolling takeoff procedure is expedited by:
Operating simultaneously the front propulsor and aft propulsor of each power plant and increasing simultaneously and rapidly as indicated in paragraph 1(k) the acceleration of the front fan and the aft fan for all power plants;
Performing one-step rolling takeoff procedure directly from brakes release to the takeoff thrust setting without halting for certain time the takeoff procedure on a certain intermediary point between the brakes release or the rolling takeoff point and the takeoff thrust setting;
b) One engine inoperative (OH) takeoff distance is reduced wherein the rolling takeoff procedure is expedited by:
Operating simultaneously the front propulsor and aft propulsor of each power plant and increasing simultaneously and rapidly as indicated in paragraph 1(k) the acceleration of the front and the aft fan for all power plants including the power plant with the failed core engine;
Performing one-step rolling takeoff procedure directly from brakes release to the takeoff thrust setting without halting for certain time the takeoff procedure on a certain intermediary point between the brakes release and the takeoff thrust setting;
Providing back up thrust after core engine failure for the power plant with a failed core engine as indicated in paragraph 1(d);
Reducing power plant windmill and spillage drag and eliminating aircraft control drag after core engine failure wherein the power plant with the failed engine core is still providing back up thrust as indicated in paragraph 1(d);
c) All engines operating (AEO) accelerate stop distance is reduced during rolling takeoff by performing the following steps in the acceleration phase and deceleration phase respectively:
Operating the front and the aft propulsors simultaneously on each power and increasing simultaneously and rapidly as indicated in paragraph 1(k) the acceleration of the front and the aft fan for all power plants from brakes release during the acceleration phase of takeoff until aircraft system/component failure event; and performing one-step rolling takeoff procedure directly from brakes release to the takeoff thrust setting during the acceleration phase of takeoff until aircraft system/component failure event (Vf: failure speed);
Eliminating the thrust of all propulsors of all power plants after the aircraft system/component failure during the deceleration phase;
Operating 2 propulsors simultaneously as thrust reversers on each power plant during the deceleration phase of takeoff after aircraft system/component failure; and increasing simultaneously and rapidly the acceleration of the front and the aft fan for all power plants as indicated in paragraph 1(k) to provide the maximum reversed thrust
d) One engine inoperative (OH) accelerate stop distance is reduced by performing the following steps in the acceleration phase and deceleration phase respectively:
Operating the front propulsor and the aft propulsor simultaneously on each power plant and increasing simultaneously and rapidly the acceleration of the front fan and the aft fan for all power plants as indicated in paragraph 1(k) plant from brakes release until core engine failure speed (Vef);
Performing one-step rolling takeoff procedure directly from brakes release to the takeoff thrust setting during the acceleration phase of takeoff before core engine 3 failure speed (Vef);
Eliminating the thrust of all propulsors of all power plants after core engine failure during the deceleration phase;
Providing back up reversed thrust through the front propulsor and the aft propulsor of the power plant with the failed core engine as indicated in paragraph 1(d);
Providing reversed thrust through all propulsors of the rest of the power plants; and increasing simultaneously and rapidly as indicated in paragraph 1(k) the acceleration of the front fan and the aft fan for all power plants to provide rapidly the maximum reversed thrust;
e) During RTO the maximum brake energy speed (Vmbe) and the maximum brake energy are reduced by:
Reducing all engines operating (AEO) accelerate stop distance required (ASDR) using the method illustrated in paragraph 4(c);
Reducing one engine inoperative (OEI) accelerate stop distance required (ASDR) using the method illustrated in paragraph 4(d);
Reducing the accumulation of the brakes heat after performing successive short flights since the brakes cooling is very slow by performing the steps mentioned in paragraph 7(e);
f) The takeoff climb gradient for aircraft is increased after core engine failure by:
Providing back up thrust to the power plant with the failed core engine through the front fan and the aft fan of the power plant with failed core engine wherein the core engine(s) of other operating power plant(s) and APU provide back up power to drive the front fan and the aft fan;
Operating two propulsors simultaneously and increasing propulsors acceleration of the power plant with the failed core engine;
Reducing power plant windmill and spillage drag and eliminating aircraft control drag after core engine failure wherein the power plant with the failed engine core is still providing back up thrust through its front propulsor and aft propulsor as explained in paragraph 1(d);
g) The takeoff thrust time limit is increased (more than 5/10 minutes) after a core engine failure by reducing the load from the operating core engine 3 of the other operating power plant by:
Providing back up thrust to the power plant with the failed core engine through the front fan and/or the aft fan, wherein the APU and the core engine(s) of other operating power plant(s) provide back up power to drive the said front fan and/or the aft fan; therefore reducing the load and temperature from the operating core engine(s);
Reducing windmill drag and spillage drag of the core engine and eliminating aircraft control drag after core engine failure, wherein the power plant with the failed core engine is still providing back up thrust through its front propulosr and/or aft propulsor as explained in paragraph 1(d);
h) The obstacle clearance for aircraft is increased after core engine failure by:
Decreasing all engines operating (AEO) takeoff distance as explained in paragraph 4(a) and one engine inoperative (OEI) takeoff distance as indicated in paragraph 4(b);
Providing back up thrust to the power plant 1 with the failed core engine through the front fan and/or the aft fan, wherein the core engine(s) of other operating power plant(s) and APU provide back up power to drive the front fan and the aft fan;
Increasing propulsors acceleration of the power plant with the failed core engine as explained in paragraph 1(k) and operating both propulsors simultaneously;
Reducing core engine windmill and spillage drag and eliminating aircraft control drag after core engine failure, since the power plant with the failed engine core is still providing back up thrust through its front fan and aft propulsor as explained in paragraph 1(d);
i) The driftdown altitude is improved after core engine failure by:
Providing back up thrust through the front fan and the aft fan wherein the core engine(s) of other operating power plant(s) and APU provide back up power to drive the front fan and the aft fan, increasing propulsors acceleration of the power plant with the failed core engine and operating 2 propulsors simultaneously;
Reducing core engine windmill and spillage drag and eliminating aircraft control drag after core engine failure, since the power plant with the failed engine core is still providing back up thrust through its front propulsor and aft propulsor as explained in paragraph 1(d);

5. The airplane of claim 1, wherein approach and landing performance are improved wherein:
a) The approach climb gradient for aircraft is increased after core engine failure by:
Providing back up thrust through the front and the aft fan of the failed power plant wherein the core engine(s) of other operating power plant(s) and the APU provide back up power to drive the said front and the aft fan; and increasing propulsor acceleration of the power plant with the failed core engine and operating 2 propulsors simultaneously;
Reducing windmill drag of the power plant and eliminating spillage drag and control drag after core engine failure since the power plant with the failed engine core can still provide back up thrust through its front and aft propulsor as indicated in paragraph 1(d);
b) The landing climb gradient for aircraft is increased after core engine failure by:
Providing back up thrust through the front and the aft fan of the failed power plant wherein the core engine(s) of other operating power plant(s) and the APU provide back up power to drive the said front and the aft fan; after core engine failure the power plant with the failed engine core can still providing back up thrust through its front and aft propulsor as indicated in paragraph 1(d);
Increasing propulsor acceleration of the power plant with the failed core engine and operating 2 propulsors simultaneously;
Reducing windmill drag of the power plant and eliminating spillage drag and control drag after core engine failure, wherein the power plant with the failed engine core is still providing back up thrust through its front and aft propulsor;
c) The landing distance is decreased wherein:
The approach speed is reduced by:
Reducing the approach idle thrust using steps in paragraphs 2(a) and 2(b);
Using low drag approach by using less flap setting for approach and landing and using the suitable approach idle thrust as indicated in paragraphs 2(a) and 2(b).
Using the thrust reversers if needed when aircraft speed is higher;
The landing distance is decreased during the flare by:
Decreasing the floating effect during the flare by cutting of the thrust and using the thrust reversers;
Eliminating the thrust at the end of the flare or at the beginning of the touchdown,
Providing the maximum thrust reversers if needed by using the front and aft propulsors at the beginning of the touchdown;
d) The go-around procedure is improved wherein:
In case of core engine failure the power plant with the failed core engine provides back up thrust through the front and aft fan as indicated in paragraph 1(d);
In case of failure of one fan the other fan is driven to maximum speed;
The fan acceleration is nearly instantaneous from low approach thrust to go-around thrust;

6. The airplane of claim 1, wherein the overall aircraft weight is decreased, wherein:
a) The weight and size of a power plant and even certain parts of aircraft are reduced wherein:
After core engine failure a power plant can still provide back up thrust as explained in paragraph 1(d) through the 2 propulsors of this power plant, in addition to the thrust of other operative power plant(s) in order to ensure certain takeoff aircraft performance requirements such that the core engine is not oversized and overpowered;
After one propulsor failure, a power plant can still provide thrust as explained in paragraph 1(d) through the other operative propulsor in order to ensure certain takeoff aircraft performance requirements such that the propulsor is not oversized and overpowered;
b) The weight of fan casing and engine nacelle and engine pylon is reduced by fitting the power plant with front fan and aft fan co-axially, instead of one big fan with heavier fan casing for blade containment in case of blade-out and big nacelle;
c) On aircraft with wing mounted-engines the size of the rudder and the vertical stabilizer are reduced wherein:
After core engine failure back up power is provided as explained in paragraph 1(d) to drive the fans of the power plant with the failed core engine, such the fans provide back up thrust to counter the yawing moment due to the thrust asymmetry;
After the failure of one the fan on a power plant the other opposite operative fan on the other opposite power plant is shutdown to counter the yawing moment due to the thrust asymmetry;
The shorter fan spool up/down time as described in paragraphs 1(k) and 1(l) allows using asymmetric thrust to generate sufficient sideslip for crosswind landings;
d) On aircraft with wing mounted-engines the weight of the wing is decreased wherein:
The wing bending moment due to the engine weight is increased by installing the power plant farther from the fuselage/aircraft centerline such that the increased wing bending moment due to engine weight will counter the wing bending moment due to lift and therefore lighten wing structural weight;
Installing power plant farther from fuselage/aircraft centerline will not increase the yawing moment after core engine failure as explained in paragraph 6(c); after core engine failure the yawing moment is countered by back up thrust due to the thrust asymmetry in case of core engine failure;
e) The size of the landing gear is reduced wherein:
The ground clearance for low wing-mounted engines is increased by providing the power plant with 2 small fans instead of one fan with big diameter;
The ground clearance for low wing-mounted engines is increased by installing power plant farther from the fuselage as indicated in paragraph 6(d) in a dihedral wing;
f) The fuel Jettisoning system is not installed on certain large aircraft that usually require this system wherein:
After core engine failure the power plant with the failed core engine provides back up thrust as indicated in paragraph 1(d) and achieves approach climb gradient and landing climb gradient requirements according to FAR 25.1001 since aircraft can land overweight;
The power plant with one failed propulsor can still provide thrust through the other operative propulsor as indicated in paragraphs 1(e) and 1(f), and improves approach climb gradient and landing climb gradient requirements according to FAR 25.1001 since aircraft can land overweight;
g) The RAM (ram air turbine) is not installed on aircraft wherein after all core engines and APU failure or shutdown due to fuel problem the power plant can still provide electric power to aircraft systems wherein:
The windmilling front fan drives the front motor-generator to generate back up electric power after disconnecting the turbine from the front fan, and such that the front motor-generator provides back up electric power to certain critical aircraft systems; and
The windmilling aft fan drives the aft motor-generator to generate back up electric power after disconnecting the free turbine from the aft fan such that the aft motor-generator provides back up electric power to certain critical aircraft systems; and
after all core engines and APU failure or shutdown due to fuel problem all power plants can generate back up electric power to drive at least one propulsor to provide aircraft back up thrust and controllability especially at low speed and low altitude for a safe emergency landing;
h) The weight and size of the core engine of the power plant is reduced wherein:
The APU is considered as separate core engine and may have the same core engine of aircraft power plant; the APU provides power along with core engine to aircraft systems during ground and flight operations such that the APU relieves loads on the core engine;
the APU provides power to the front and aft propulsors along with the core engine to generate thrust and reversed thrust during normal operation of the power such the APU relieves loads on the core engine; the APU provides power to both propulsors along with the other operative core engine to generate back up thrust and reversed thrust after core engine failure such that the APU relieves loads on the other operative core engine(s);

7. The airplane of claim 1, wherein aircraft incident/accident is reduced and aircraft safety is improved, wherein:
a) Below the minimum control ground speed (Vmcg) and after core engine failure the risk of aircraft runway excursion due to the thrust asymmetry is prevented wherein:
The power plant with the failed core engine provides automatically back up thrust if the thrust is lost or back up reversed thrust if the reversed thrust is lost through the propulsors to counter the yawing moment; or
The 2 opposite propulsors on the opposite power plant with operative core engine are shut down to counter the yawing moment;
b) At high aircraft takeoff speed (close to V1 or >V1) on ground and after core engine failure the risk of aircraft runaway excursion due to the thrust asymmetry excursion is prevented wherein:
The back up thrust is provided automatically as explained in paragraph 1(d) to the power plant with the failed core engine provides through the propulsors to counter the yawing moment;
c) After the failure of one the propulsor below the minimum control ground speed (Vmcg) the risk of aircraft runway excursion due to thrust asymmetry can be prevented by automatically shutting down the opposite propulsor on the opposite power plant to counter the yawing moment;
At high speed (close to V1 or at V1) the risk of aircraft runway excursion due to thrust asymmetry can be prevented by operating automatically the other operative propulsor in the same power plant at the maximum thrust to counter the thrust asymmetry;
d)—After core engine failure the risk of aircraft control loss due to thrust asymmetry is prevented wherein the power plant with the failed core engine provides back up thrust as explained in paragraph 1(d) through the propulsors to counter the yawing moment even below the minimum control air speed (Vmca);
After the failure of one the propulsor the risk of thrust asymmetry is reduced by operating the other propulsor on the same power plant at the maximum thrust to counter the yawing moment even below the minimum control air speed (Vmca);
e)—Overrun runway incidents and accidents are prevented:
1—During rejected takeoff (RTO) by:
Reducing all engines operating (AEO) accelerate stop distance required (ASDR) using paragraph 4(c);
Reducing one engine inoperative (OEI) accelerate stop distance required (ASDR) using paragraph 4(d);
During high speed landing by:
Reducing all engines operating (AEO) accelerate stop distance required (ASDR) using paragraph 4(c);
By reducing one engine inoperative (OEI) accelerate stop distance required (ASDR) using paragraph 4(d);
By decreasing landing distance as indicated in paragraph 5(c);
f) During high-speed RTO brakes and tires fire, landing gear and aircraft damages can be prevented by:
Reducing all engines operating (AEO) accelerate stop distance required (ASDR) using paragraph 4(c);
Reducing one engine inoperative (OH) accelerate stop distance required (ASDR) using paragraph 4(d);
Reducing the accumulation of the brakes heat after performing successive short flights since the brakes cooling is very slow by performing the steps mentioned in paragraph 7(e);
g) Improving the maximum quick turnaround weight by:
Taxiing aircraft with the proper speed and without using a lot the brakes wherein the front and/or the aft propulsor provide the adequate and optimized ground idle thrust by driving the front and/or the aft fan to the proper RPM rotation as indicated in paragraph 3 (b);
Reducing the landing speed as indicated in paragraph 5(c);
Using the maximum reversed thrust by operating the front and the aft propulsors at each landing especially for successive short flights;
h) After power plant failure the takeoff thrust time limit is increased (more than 5/10 minutes) especially in this critical phase of flight wherein:
After a core engine failure the front and the aft propulsors provide back up thrust after receiving back up power through the APU and the core engine of other power plants as indicated in paragraph 1(d) such that the operating APU relieves load and stress on the operating core engine(s);
After the failure of one propulsor the power plant can still provide the thrust through the other operative propulsor, therefore this propulsor relieves load and stress on the operating core engine(s);
After power plant failure providing back up thrust as indicated in paragraph 1(d) will eliminate or reduce windmill drag, spillage drag, and control drag, therefore takeoff thrust is reduced and the load and the stress on the operating core engine(s) is reduced;
i) After core engine failure in cruise aircraft (especially twin aircraft) driftdown altitude over high mountains and high terrain is improved wherein:
The front and the aft propulsors provide back up thrust after receiving back up power through the APU and the core engines of other power plants as per claim 1(d);
After core engine failure the windmill drag and the spillage drag of the is reduced and aircraft control drag is eliminated because the power plant with the failed core engine provides back up thrust as indicated in the paragraph 1(d);
i) The driftdown altitude is improved after core engine failure by providing back up thrust through the front and the aft fan, wherein the core engine(s) of other operating power plant(s) and APU provide back up power to drive the front and the aft fan; increasing propulsor acceleration of the power plant with the failed core engine and operating 2 propulsors simultaneously (to escape to high obstacle and high terrain, and by eliminating or reducing windmill drag, spillage drag, and control drag;
j) High energy approach incidents/accidents, rushed and unstabilized approach, and go-around are reduced by:
Using the thrust reversers through the fans in flight to reduce the excess of the speed;
Reducing approach idle thrust using steps 2(a) and 2(b) to decrease aircraft speed wherein:
The approach idle thrust is optimized and in the same time ensuring fast acceleration fan time complying with the FAA regulations FAR Part 33.73(d) & FAR Part 25-119;
Using low drag approach that is adequate with the reduced approach idle thrust;
k) Low energy approach incidents/accidents are reduced by:
Increasing simultaneously the acceleration of all propulsors for all power plants,
Operating simultaneously the front and the aft propulsor to the maximum thrust,
Decreasing stall speed and improve aircraft recovery from stall (we can use the acceleration of the fan from reduced idle thrust to go-around thrust;
l) After all core engines and APU failure or shutdown due to fuel problem all power plants can generate back up thrust and back up electric power to provide aircraft controllability and back up thrust, especially at low speed and low altitude for a safe emergency landing wherein:
The front fan provides back up thrust such that the front propulsor is driven by the front air turbine that receives ram air;
The aft motor-generator provides back up electric power to certain critical aircraft systems such that the windmilling aft fan drives the aft motor-generator to generate back up electric power after disconnecting the free turbine from the aft fan;
m) The risk of bird strike and FOD (foreign objects debris) absorption into core engine and aft fan is reduced wherein:
The core engine is provided with air inlet located in the upper side of the core engine instead of a big air inlet surrounding a big fan in a conventional turbofan engine order to prevent FOD (foreign objects debris) absorption into the core engine;
After bird strike in flight or FOD absorption on ground the front fan may face damage first and this will reduce the chance that downstream power plant components such the core engine and the aft fan may face damage, since the front fan is separate from the core engine and does not provide airflow to the core engine, therefore the operation of the core engine and the aft fan is not affected;
n) When flying low-energy approach, it is possible to salvage an increasing sink rate on an approach, to recover aircraft from stall, and to reduce aircraft stall speed by accelerating rapidly the front and the aft fan and reducing their spooling up time as explained in paragraph 1(k);

8. The airplane of claim 1 wherein, the efficiency of power-plant maintenance and safety of the maintenance and ramp crew are improved around the power plant during core engine run-up for test and troubleshooting core engine components and systems wherein:
a) It is possible to test and troubleshoot core engine components and systems safely without the risk of personnel or FOD (foreign object debris) being sucked by the fans by:
Running only the core engine since it is separated mechanically from the front and aft fan and both fans do not supply airflow to the core engine; and
Not operating the front fan by not supplying electric power to the front generator-motor and pneumatic power to the air turbine to or disconnecting the front motor-generator and the air turbine from the front fan; and
Not operating the aft fan by disconnecting the gas turbine and the aft motor-generator from the aft fan and connecting the gas turbine to the aft motor-generator;
b) The risk of FOD (foreign object damage) or personnel being sucked into the core engine is reduced by installing the air inlet of the core engine in the upper side of the core engine;
c) The jet blast and the hazards around the exhaust of the power plant and aircraft is reduced during core engine run up wherein:
The front fan is not operating by disconnecting the front motor-generator and the air turbine from the front fan or not supplying electric and pneumatic power to the front generator-motor and the air turbine respectively, such that the front fan is not generating thrust and jet blast;
The aft fan is not operating by disconnecting the gas turbine and the aft motor-generator from the aft fan, wherein the aft fan is not generating thrust and jet blast;
The gas turbine is disconnected from the aft fan and driving the aft motor-generator to recover the remaining energy of the exhaust gas of the core engine, therefore reducing the jet blast;
d) It is possible to perform efficiently and safely test and troubleshooting core engine components and systems during core engine run-up wherein:
The front and the aft fan are not operating as illustrated in paragraph 8(a) and no airflow from the fans goes through the core engine cowls, wherein fan cowls (if certain core engine components are installed on the fan case) and core engine cowls are opened and the maintenance work on core engine components and systems, such leak check can be performed efficiently and safely while core engine is running;
e) It is possible to perform core engine run up efficiently and safely for test and troubleshooting with aircraft parked at airport gate or apron without the need to tow or taxi aircraft to a remote location wherein:
The maintenance of the core engine is performed without the risk of personnel or FOD (foreign object debris) being sucked by the fans as explained in claim 8 (a) or into core engine as explained in paragraph 8 (b);
The jet blast and the hazards around the exhaust of the power plant and aircraft and airport gate/apron is reduced during core engine run up for maintenance as explained in paragraph 8(c);
It is possible to perform efficiently and safely test and troubleshooting core engine components and systems with open fan cowls and core engine cowls and core engine running as mentioned in paragraph 8 (d);

9. The airplane of claim 1 wherein, the thrust redundancy and the safety of flight operations are improved during core engine abnormal and emergency operation cases wherein:
a) After all core engines flame-out especially if the aircraft is above fuel gravity ceiling or core engines are out of windmill start limits, the air turbine is supplied by ram air through a valve and the front fan is windmilling; the air turbine and the windmilling front fan drive the front motor-generator that delivers electric power to the aircraft fuel boost pump(s), ignition system, and the starter-generator of the core engine (in addition to certain aircraft components) to restart the core engine;
b) After all core engines flame-out especially if the aircraft is above fuel gravity ceiling or core engines are out of windmill start limits the aft turbine is disconnected from the aft fan and the aft motor-generator; and the aft fan is windmilling and drives the aft motor-generator that delivers electric power to the aircraft fuel boost pump, ignition system, and the starter-generator of the core engine (in addition to certain aircraft components) to restart the core engine;
c) After core engine fire and preferably after a short period of cool down of the core engine the power plant can still provide back up thrust or reversed thrust if needed as per paragraph 1(d) through the front and aft fan;

10. The airplane of claim 1 wherein, the noise is reduced engine noise on ground and in flight wherein:
One step rolling takeoff procedure and rapid acceleration of the front and the aft fan reduce the takeoff roll and aircraft get airborne earlier which result in higher flight path and decrease the airplane noise perceived at ground around airport surroundings;
The low speed airflow ejected by the front and the aft fan reduces the noise of the engine;
The speed of tip of the fan blades is reduced wherein the size of the blade is reduced by incorporating 2 fans (the front and the aft) instead of one big fan;
The core engine doesn't generate its own thrust wherein the energy of the exhaust gas of the core engine is recovered by driving a free turbine such that the velocity of the exhaust gas is reduced;
Installing engine farther from the fuselage or the aircraft centerline as illustrated in paragraph 6 (d) reduce engine noise inside the aircraft cabin and cockpit;
The airplane-to-ground noise level is reduced wherein it is possible to fly a higher flight path for the approach and descent and farther from the community living near the airport by performing steep approach and descent; and
The airplane-to-ground noise level is reduced by performing the steep descent and approach and maintaining certain speed and rate of descent by eliminating the thrust and generating reversed thrust during the descent using the fans as thrust reverser as indicated in paragraphs 1(g), 1(j), and 1(i); or
using a reduced idle approach thrust setting during the approach as indicated in paragraphs 2(a), 2(b), and 2(m);
The noise is reduced during core engine run-up for maintenance especially at night by running only the core engine and not operating the front and the aft fan as illustrated in paragraph 9(a) since there are certain noise restrictions and sometimes curfew at certain airports;
Running only the core engine since it is separated mechanically from the front and aft fan and both fans do not supply airflow to the core engine, and
Not operating the front fan by not supplying electric and pneumatic power to the front generator-motor and the air turbine respectively or disconnecting the front motor-generator and the air turbine from the front fan; and
Not operating the aft fan by disconnecting the gas turbine and the aft motor-generator from the aft fan and connecting the gas turbine to the aft motor-generator;
The noise is reduced during taxiing on congested airport (long queue at taxiway) by running only the core engine and not operating the front and the aft fan as illustrated in paragraph 8 (a).
